(19) United States
(12) Patent Application Publication
(10) Pub. No.: US 2013/0141029 A1
(43) Pub. Date: Jun. 6, 2013

(54) Active pre-programmable reminder system for special moments

(71) Applicant: Oren Partuk, Tel Aviv (IL)

(72) Inventor: Oren Partuk, Tel Aviv (IL)

(21) Appl. No.: 13/373,877

(22) Filed: Dec. 5, 2011

(51) Int. Cl. H02P 1/04

(52) U.S. Cl. 318/452

(57) ABSTRACT

An active system that can be pre-programmed to operate at a specific, emotionally significant moment. The system includes a meaningful sculpture (such as a heart, Star of David, cross, and so on), which in normal position is in a disassembled and non-harmonious state and which only when the preprogrammed moment arrives, is activated so that the sculpture is reassembled, becomes complete and harmonious. The system includes a casing, a motor, an internal clock, a transmission system, and a device that connects the sculpture parts to the transmission system. The system also includes display screens and a command and control panel.

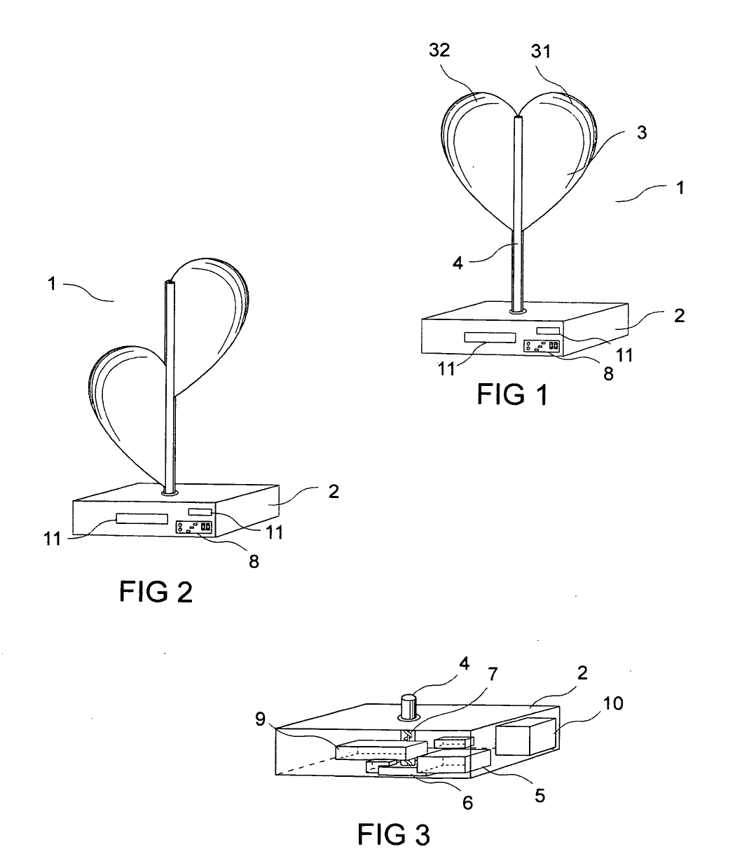

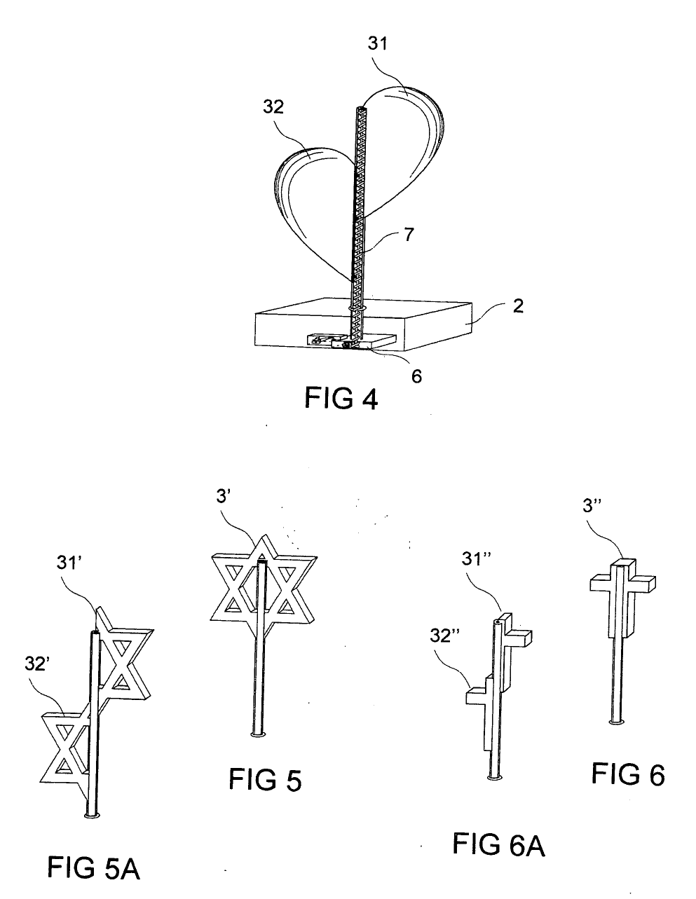

### TECHNICAL FIELD

An active pre-programmable reminder system for special moments , or more specifically, a system that can be pre-programmed so as to automatically complete a sculpture or special form at a preset moment.

### BACKGROUND ART

Among certain parts of the general public there is a need to remind and remember moments that have occurred and that have special significance, such as emotional significance, religious significance or, in fact, any possible kind of significance. The present invention is an active system that offers an appropriate response to the said need.

### THE INVENTION

The present invention refers to an active system (1) that can be pre-programmed so as to operate at a special, preset moment. The user can pre-program the system (1) so that it operates at a specific pre-defined moment. Such specific moment can have emotional or other significance for the user or any other person (or a public) in whose vicinity the system is located during its automatic operation.

The system (1) comprises a form or sculpture (3) that has some significance (such as emotional, religious, nationalistic, or other). The sculpture (3) is in a split and disharmonious state, and only when the pre-programmed moment arrives, is the sculpture (3) assembled to become whole and harmonious. In the attached drawings, the sculpture is split into two parts, although the invention refers and covers also sculptures that are made of a single part or that are split into a greater number of parts.

The system (1) comprises the following main components: a casing (2), a sculpture (3), a holding device, which can be shaped like a central shaft (4) to which the said sculpture is attached, a clock (5), a central motor (6), a transmission system (7), a control panel (8), and a command and control mechanism (9). The system (1) can include additional components such as an electric power source (10) that supplies the system, visual displays (11), a music or sound system, a lighting system, a USB or Bluetooth connection option or a other similar device, etc.

The casing (2) of the system (1) can be made in a variety of shapes and sizes and can be manufactured from a variety of materials. The casing (2) is designed to serve as a base and mount for the system (1) and it houses the system's internal mechanisms and components, such as the clock mechanism, motor, transmission parts, control mechanism, and power source.

The sculpture (4) can be made in a variety of shapes and sizes and can be manufactured from a variety of materials. The sculptures (4) depicted in the drawings are shaped like a heart (expressing feelings of love), a Star of David (expressing Jewish sentiments) and a cross (expression religious feelings in the Christian world). The sculpture can be made of a single piece, or it can be split into two parts or more.

The holding device (4) can be made in a variety of shapes and sizes and can be manufactured from a variety of materials. It is recommended that the holding device (4) be shaped like a long, cylindrical shaft, although the present invention also refers to and covers holding devices of other shapes. The holding device (4) protrudes from the casing (2), preferably upward, and the parts of the sculpture (3) are attached to it.

The system is equipped with a clock (5), which can be the central mechanism of any known and existing clock. The role of the clock (5) is to enable the user to control the system activation by pre-setting the exact moment (date, hour and minute) at which the system is to start operating. The clock can also serve as an alarm clock.

The system's motor (6) can be an electric motor, although the present invention also refers to and covers motors that operate according to different principles.

The main function of the motor (6) is to operate the transmission system (7) of the system (1).

The system's transmission system (7) links the motor (6) to the parts of the sculpture (4) so that when a command to operate is given, the motor moves the parts of the sculpture (4) [or only one part of it] until the sculpture is completed by causing the transmission system to move the parts of the sculpture. The transmission system (7) can be one of a variety of known and existing transmission systems composed of cogwheels, cables, straps, belts, and so on.

The control panel (8) of the system (1) is designed to enable the user to control the system's operation. The control system (8) is equipped with pushbuttons or other means for activating the system, for setting the time at which the system is to activate, and for selecting the system's mode of operation (eg. playing music, turning on lights, writing text designed to appear when the system is activated). The control panel (8) is also equipped with an option for USB connection or any similar connection with the same function. Using the USB connection, the required music can be uploaded to the system and the text that is to be displayed on the display screens can be determined, as explained in the present application.

The control mechanism (9) of the system (1) is designed to control the operation of the system and all of its components, to receive commands from the control panel, and to activate the motor and the other system components.

The system (1) can be supplied by electrical power, for instance by connecting the system to the mains, in which case the system can also include an internal transformer. At the same time, or alternately, the system can be supplied by an internal power source, such as regular or rechargeable batteries. All electrical components required to power the system are designated in the drawings by the number (10).

The system's display screens (11) are designed to display relevant information to the user, such as the day of the week, the date, the exact time, the time at which the alarm clock is set to go off, as well as any text intended to indicate the pre-programmed moment and its personal, emotional or other significance.

The method of operation of the system (1) and its components, and the interrelations between them are as follows: Using the control panel (8), the user sets the exact time at which the system is to activate, in other words, the moment at which the parts of the sculpture (4) will be re-assembled. The control panel (8) can include an option whereby the user can set lighting and/or sound (music) to be lit and/or played at or near the time at which the system is activated. In addition, the control panel (8) can include an option whereby the user can set a pre-written text (which is typed on the control panel or uploaded via USB) to appear on the screen at or near the time at which the system is activated. The data programmed into the control panel, or specifically the system activation time and the desired mode of operation, are saved in the system's control mechanism (9). At the designated time, the control mechanism activates the motor, which assemble the parts of the sculpture by moving the transmission system. After a pre-set time (either default or pre-set the user), the motor disassembles the sculpture back to its initial state.

The system (1), including all of its possible designs, can serve as a lovers gift, whereby users can surprise each other by pre-setting the system to activate so as to mark the couple's special moments or other moments, as indicated, for instance, by the text that can be included and which will appear on the system's display screen. The operation of the system is intended to elicit an emotional response by those in its vicinity and it constitutes an additional means of communication between people. The system can also serve as a means of moving people within the context of community life, for instance, by placing the system at a place that has special significance, where it will operate at a specific moment.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

### DESCRIPTION OF THE DRAWINGS

The drawings attached to the application are not intended to limit the scope of the invention and the possible ways of its application. The drawings are intended only to illustrate the invention and constitute only one of many possible ways of its application.

Drawing No. 1: Drawing No. 1 shows an external view of the system, including the casing (2), two parts of the sculpture (3) which is designed as a heart [the two parts (31) (32) are in assembled state], the holding device (central shaft) (4), control panel (8), and display screens (11).

Drawing No. 2: Drawing No. 2 shows an external view of the system (1), including the two parts of the sculpture (3) in split state [parts (31) (32)].

Drawing No. 3: Drawing No. 3 depicts the internal mechanisms of the system (1), including the casing (2), base of central shaft (4), clock mechanism (5), motor (6), part of transmission system (7), control mechanism (9), and electrical power source and/or transformer (10).

Drawing No. 4: Drawing No. 4 depicts some of the internal parts of the system (1), including the casing (2), motor (6), transmission system (7) which extends also along the central shaft (4) and two parts of the sculpture (3).

Drawing No. 5: Drawing No. 5 depicts an example of a Star of David shaped sculpture (3′) in assembled state.

Drawing No. 5A: Drawing No. 5A depicts an example of a Star of David shaped sculpture (3′) in split state.

Drawing No. 6: Drawing No. 6 depicts an example of a cross shaped sculpture (3″) in assembled state.

Drawing No. 6A: Drawing No. 6A depicts an example of a cross-shaped sculpture (3″) in split state.

What is claimed is:

1. A system that can be programmed to operate at a certain pre-defined moment, which includes the following components: A sculpture that is complete or split into two or more parts; a holding device that connects the sculpture parts to the body of the said system; a clock; a motor; a transmission system; and a command and control panel, such that, using the control panel, the user can pre-set the moment at which the said system is to activate the said motor, which using the said transmission system will assemble the said sculpture pieces and turn them into complete sculpture.
